(19) United States
(12) Patent Application Publication
(10) Pub. No.: US 2020/0124241 A1
(43) Pub. Date: Apr. 23, 2020

(54) MULTIPLE MOUNT LED LIGHT WITH TWO WAY USB

(71) Applicant: VECTOR PRODUCTS, INC., BOCA RATON, FL (US)

(72) Inventor: MATHEW INSKEEP, HIGHLAND BEACH, FL (US)

(21) Appl. No.: 16/658,637

(22) Filed: Oct. 21, 2019

Related U.S. Application Data
(60) Provisional application No. 62/748,952, filed on Oct. 22, 2018.

(51) Int. Cl. F21L 4/08; F21V 23/06; F21V 21/096; F21V 23/04

(52) U.S. Cl. CPC F21L 4/08; F21V 23/06; F21Y 2115/10; F21V 23/0414; F21V 21/0965

(57) ABSTRACT

A LED light having multiple mounting capabilities, with the light preferably rechargeable. The LED light housing can be provided with a magnetic member, such as, preferably at its back or bottom area, for mating or attaching to a preferred magnetic ball. The ball can fit within multiple mounting or wearable platforms/mounts such as, but not limited to, a headlamp, wrist light, bike light, hanging light, etc. Preferably, the same light can be used for different events depending on the user's needs. Preferably, the USB port can be used to charge the LED light battery, and also allow the battery to be used to charge other electronic devices, such as, but not limited to a smart phone, allowing the USB port to be a two-way port. The back surface of the light housing can be provided with a cavity wherein a magnet member is recessed within. When connecting the light housing to one of the connection platforms/mounts, the platform preferably contains a metal or other magnetic material ball sized to be inserted within the cavity to create a relatively strong magnetic connection.

This application claims the benefit of and priority to U.S. Provisional Patent Application Ser. No. 62/748,952, filed Oct. 22, 2018, which is incorporated by reference in its entirety for all purposes.

### 1. FIELD OF THE DISCLOSURE

The disclosure relates generally to portable lighting devices charging stations and particularly to a lighting device having multiple mounting or securement capabilities.

### 2. BACKGROUND

Often when participating in an activity the user needs the assistance of a light. Typically, a separate light has to be purchased for each activity. Additionally, other than providing light, usually the light device employed for the activity does not have any other functions. It is to these shortcomings that the disclosed novel multiple mount light described below is directed.

### SUMMARY OF THE DISCLOSURE

A novel LED light having multiple mounting capabilities is generally disclosed. Preferably, the LED light can be rechargeable. In a preferred embodiment, a rechargeable LED ‘flashlight’ with power in/power out capabilities, preferably wearable or mountable, can be provided. The LED light housing can be provided with a magnetic member, such as, preferably at its back or bottom area, for mating or attaching to a preferred magnetic ball. The ball can fit within multiple mounting or wearable platforms/mounts such as, but not limited to, a headlamp, wrist light, bike light, hanging light, etc. Preferably, the same light can be used for different events depending on the user's needs. Preferably, the USB port can be used to charge the LED light battery, and also allow the battery to be used to charge other electronic devices, such as, but not limited to a smart phone. Thus, the USB port can be a two-way port, allowing energy to enter through the port for charging the LED light or allow energy to leave through the port to charge other electronic devices (preferably, though not limiting, with or without the light also being on at the same time). Though preferably, an LED light/bulb is used, such is not considered limiting, and other light/light bulb types can be used and are considered within the scope of the disclosure.

Preferably, the back surface can be provided with a cavity wherein a magnet member is recessed within. When connecting the light housing to one of the connection platforms/mounts, the platform preferably contains a metal or other magnetic material ball sized to be inserted within the cavity of the LED light housing where the magnet is recessed within. Accordingly, a strong magnetic connection is made between the magnetic material ball and the recessed magnet within the cavity to securely retain the LED light housing to the connection mechanism chosen.

Conventional lighting/charging circuitry can be included within the housing and in communication with a switch for conventional operation of such circuitry. Applicant also incorporates by reference the entire disclosures and illustrations as if set forth herein in its following U.S. patents and published patent application”, as if the disclosures and illustrations were fully set forth herein, as well as providing non-limiting examples of charging technology, two-USB capabilities technology that can be used with the instant disclosure:
1. U.S. application Ser. No. 15/378,187 filed Dec. 14, 2016 entitled “Battery Booster With Integrated Modular Compressor and Inverter”;
2. U.S. Pat. No. 10,110,055, issued Oct. 23, 2018 entitled “Fast Charging High Energy Storage Capacitor System Jump Starter”;
3. U.S. Pat. No. 9,843,208, issued Dec. 12, 2017, entitled High Power rechargeable flashlight with two way universal serial bus”;
4. U.S. application Ser. No. 15/984,789, filed May 21, 2018, entitled “Battery Charger with Detachable Battery”;
5. U.S. application Ser. No. 15/378,142, filed Dec. 14, 2016, entitled “High Power Rechargeable Spotlight with Two Way Universal Serial Bus”;
6. U.S. application Ser. No. 15/349,324, filed Nov. 11, 2016, entitled “Portable Power Station Unit With Two Way Universal Serial Bus”;
7. U.S. application Ser. No. 15/440,079, filed Feb. 23, 2017, entitled “Portable Power Tool Capacitor Jump Start System”;
8. U.S. application Ser. No. 14/038,503, filed Sep. 26, 2013, entitled “High-Efficiency Battery Charger”;
9. U.S. application Ser. No. 13/490,599, filed Jun. 7, 2012, entitled “Battery With Integrated Power Inverter”; and
10. U.S. application Ser. No. 12/788,040, filed May 26, 2010, entitled “Multi-Purpose Battery Jump Starter and Reconditioner”.

Accordingly, the disclosed multiple mount LED light allows the user to only have to use one light for integration into multiple useful platforms/mounts. The disclosed LED light can also act as a useful hand-held or worn rechargeable flashlight having power to also recharge or partially recharge one or more other electronic devices.

### BRIEF DESCRIPTION OF THE DRAWINGS

FIG. 1 is a perspective view of a non-limiting embodiment for the novel multiple mount LED light with two-way USB shown in a wrist light configuration in accordance with the present disclosure;

FIG. 2 is a top view of a non-limiting embodiment for the novel multiple mount LED light with two-way USB;

FIG. 3 is a bottom view of the multiple mount LED light of FIG. 2 showing the magnetic member for securing the light;

FIG. 4 is a perspective view of a non-limiting wrist strap embodiment having an magnetic and/or metal ball in accordance with the present disclosure;

FIG. 5 is a perspective view of the multiple mount LED light of FIG. 2 being used in a charging configuration to charge an electronic device in accordance with the present disclosure;

FIG. 6 is a perspective view of the multiple mount LED light of FIG. 2 showing in a headlamp configuration in accordance with the present disclosure;

FIG. 7 is an exploded view of the headlamp configuration light of FIG. 6;

FIG. 7a is a side view of a bicycle or cylindrical bar mount configuration for the multiple mount LED light of FIG. 2 in accordance with the present disclosure;

FIG. 8 is a front view of a hanging hook mount configuration for the multiple mount LED light of FIG. 2 in accordance with the present disclosure;

FIG. 9 is a stand mount configuration for the multiple mount LED light of FIG. 2 in accordance with the present disclosure; and

FIG. 10 is a compilation view illustrating the multiple mount LED light of FIG. 2 in its various preferred, though non-limiting, uses and configurations in accordance with the present disclosure.

### DETAILED DESCRIPTION

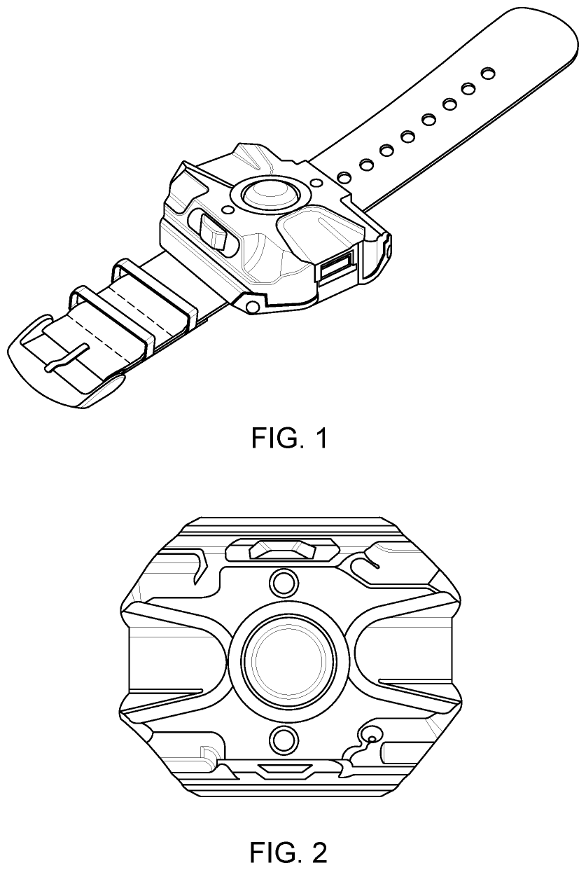

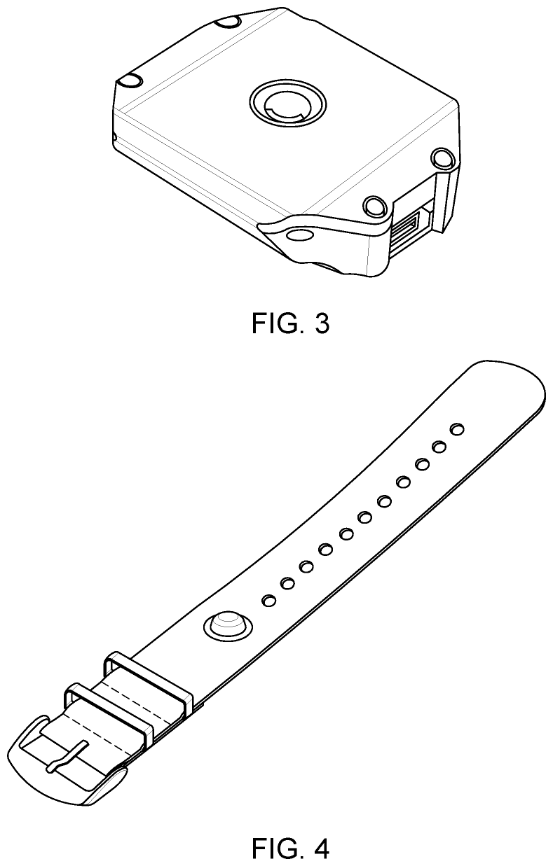

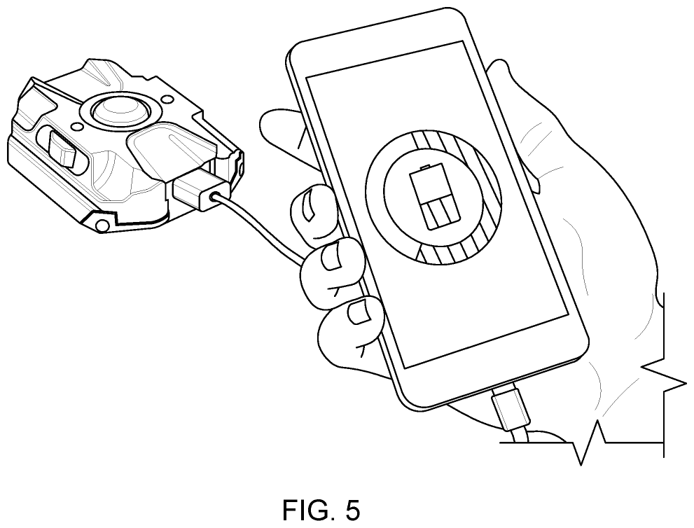

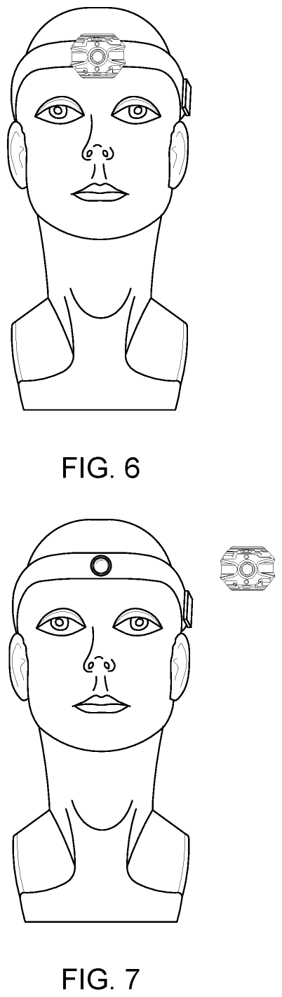

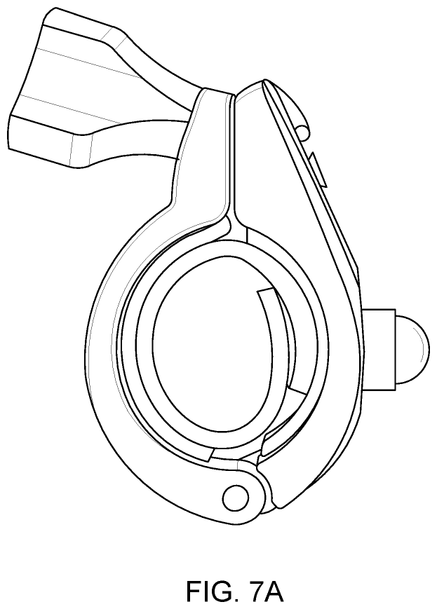

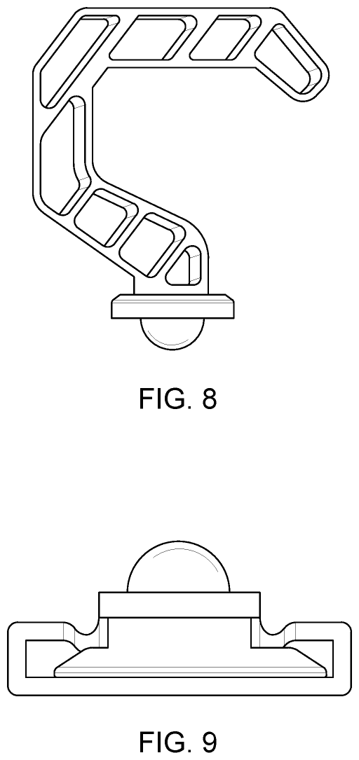

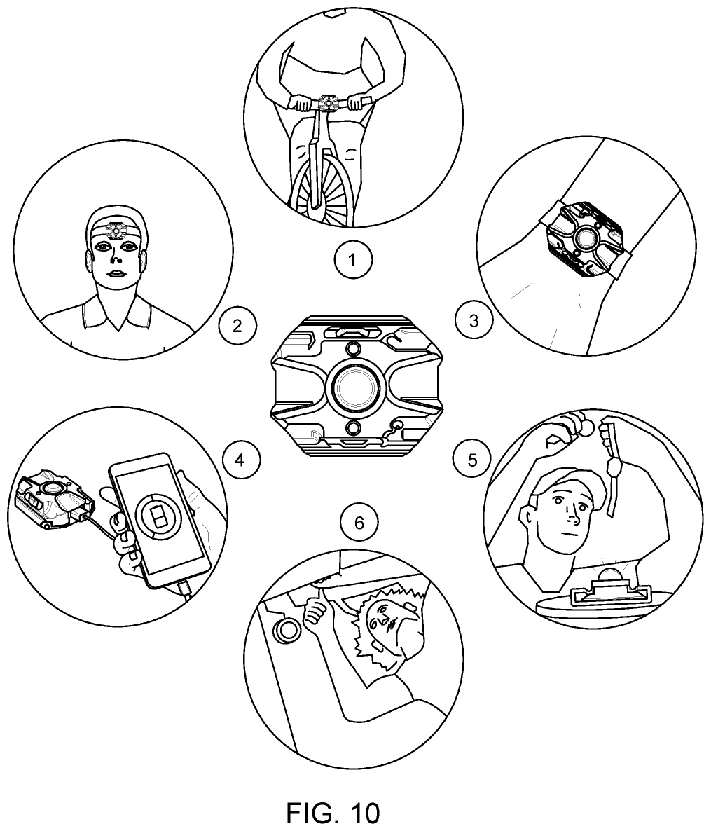

As seen in the drawings a novel LED light having multiple mounting capabilities is shown, with the LED light preferably being rechargeable (See FIGS. 1 and 2). A USB port can be provided for recharging the light battery, while also preferably allowing for power in/power out capabilities to allow for charging other electronic devices that are attached through a USB cord or cable (See FIG. 5). The LED light housing can be provided within a magnetic member, such as, preferably at its back or bottom area (See FIG. 3). A preferred magnetic ball can fit within the opening containing the magnetic for mating/attaching to the magnet. The attachment ball can be incorporated in or more different platforms such as, but not limited to, a headlamp (FIGS. 6 and 7), wrist light (FIG. 4), bike light (FIG. 7a), hanging light (FIG. 8), stand (FIG. 9), etc. Preferably, the same light can be used for different events depending on the user's needs. Preferably, the USB port can be used to charge the LED light battery, and also allow the battery to be used to charge other electronic devices, such as, but not limited to a smart phone.

Preferably, the back surface can be provided with a cavity wherein a magnet member is recessed within (FIG. 2). When connecting the light housing to one of the connection platforms, the platform preferably contains a metal or other magnetic material ball sized to be inserted within the cavity of the LED light housing where the magnet is recessed within. Accordingly, a strong magnetic connection is made between the magnetic material ball and the recessed magnet within the cavity to securely retain the LED light housing to the connection mechanism chosen.

In certain uses, the light can be a hand-held rechargeable bilateral USB, light with magnetic attachment capable of attaching/affixing to various platforms such as headband, wristband bicycle, hook.

Preferably, the device provides for a rechargeable LED ‘flashlight’ with power in/power out capabilities. The light device is preferably connected to one or more different platforms through a magnetic ball that can fit within multi platforms such as headlamp, wrist light, bike light, hanging light, stand etc. In one non-limiting embodiment, the ball can be constructed from steel, though other magnetic materials can also be used and are considered within the scope of the disclosure.

Preferably, the light can be connected with respect to the housing in a pivotable or rotatable or adjustable configuration. Also, an on/off switch can also be provided for turning the light on and off, as well as also for supplying power to another electronic device that is connected (i.e. via a cable connected to the USB port) for recharging.

The various attachment platforms allow for hands-free lighting in various situations.

Applicant incorporates by reference the entire disclosure and drawings in U.S. Pat. No. 9,515,419 issued on Dec. 6, 2016 entitled High Power Rechargeable Flashlight With Two Way Universal Serial BUS, as if the disclosure and illustrations were fully set forth herein.

Though preferably the battery used for powering the light is rechargeable, it is also within the scope of the disclosure, to include a replaceable battery/power source for energizing the light.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All components of the multiple mount LED light and their locations, electronic communication methods between the system components, wiring, attachment or securement mechanisms, mechanical connections, dimensions, values, shapes, materials, light sources, light bulbs, charging methods, battery types, tools and devices that can be used therewith, etc. discussed above or shown in the drawings, if any, are merely by way of example and are not considered limiting and other component(s) and their locations, electronic communication methods, wiring, attachment or securement mechanisms, mechanical connections, dimensions, values, shapes, materials, light sources, light bulbs, charging methods, battery types, tools and devices that can be used therewith, etc. can be chosen and used and all are considered within the scope of the disclosure.

The benefits, advantages, solutions to problems, and any element(s) that may cause any benefit, advantage, or solution to occur or become more pronounced are not to be construed as a critical, required, or essential features or elements of any or all the claims.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

While the novel multiple mount LED light has been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A light having multiple removable mounting capabilities, comprising:
a light housing having a front area and a bottom surface, the bottom surface defining a cavity;
a light assembly housed by the light housing; and
a magnetic member disposed within the cavity.

2. The light having multiple removable mounting capabilities of claim 1 further comprising an externally accessible electrical port housed by the light housing.

3. The light having multiple removable mounting capabilities of claim 2 wherein the electrical port is in electrical communication with the light assembly.

4. The light having multiple removable mounting capabilities of claim 3 wherein the light assembly including a light and a rechargeable power source.

5. The light having multiple removable mounting capabilities of claim 4 wherein the light is at least one LED light.

6. The light having multiple removable mounting capabilities of claim 4 wherein the electrical port is a two-way USB port, wherein the two-way USB port allows the rechargeable power source to be recharged through the USB port and also allows the rechargeable power source to charge another electronic device when the another electronic device is directly or indirectly connected to the USB port through an electrical connection cord.

7. The light having multiple removable mounting capabilities of claim 1 wherein the light assembly including a externally accessible switch for turning a light of the light assembly on and off.

8. The light having multiple removable mounting capabilities of claim 1 further comprising a metal member shaped to be at least partially received within the cavity through a magnetic connection with the magnetic member, the metal member secured to a physical object.

9. The light having multiple removable mounting capabilities of claim 8 wherein the physical object is a wristband, a wrist strap, a headband, a bicycle mount, a stand or a hanging hook.

10. The light having multiple removable mounting capabilities of claim 8 wherein the metal member having an at least partial round ball shape.

11. A light having multiple removable mounting capabilities, comprising:
a light housing having a front area and a bottom surface, the bottom surface defining a cavity;
a light assembly housed by the light housing;
a magnetic member recessed within the cavity; and
a metal member shaped to be at least partially received within the cavity through a magnetic connection with the magnetic member, the metal member secured to a physical object.

12. The light having multiple removable mounting capabilities of claim 11 further comprising an externally accessible electrical port housed by the light housing and in electrical communication with the light assembly.

13. The light having multiple removable mounting capabilities of claim 12 wherein the light assembly including at least one LED light and a rechargeable power source.

14. The light having multiple removable mounting capabilities of claim 13 wherein the electrical port is a two-way USB port, wherein the two-way USB port allows the rechargeable power source to be recharged through the USB port and also allows the rechargeable power source to charge another electronic device when the another electronic device is directly or indirectly connected to the USB port through an electrical connection cord.

15. The light having multiple removable mounting capabilities of claim 11 wherein the light assembly including a externally accessible switch for turning a light of the light assembly on and off.

16. The light having multiple removable mounting capabilities of claim 11 wherein the physical object is a wristband, a wrist strap, a headband, a bicycle mount, a stand or a hanging hook.

17. The light having multiple removable mounting capabilities of claim 11 wherein the metal member having an at least partial round ball shape.

18. A light having multiple removable mounting capabilities, comprising:
a light housing having a front area and a bottom surface, the bottom surface defining a cavity;
a light assembly housed by the light housing, the light assembly including at least one LED light and a rechargeable battery;
an externally accessible two-way electrical USB port housed by the light housing and in electrical communication with the light assembly;
a magnetic member recessed within the cavity; and
a metal member shaped to be at least partially received within the cavity through a magnetic connection with the magnetic member, the metal member secured to a physical object, the metal member having an at least partial round ball shape;
wherein the electrical port is a two-way USB port, wherein the two-way USB port allows the rechargeable power source to be recharged through the USB port and also allows the rechargeable power source to charge another electronic device when the another electronic device is directly or indirectly connected to the USB port through an electrical connection cord.

19. The light having multiple removable mounting capabilities of claim 18 wherein the light assembly including a externally accessible switch for turning a light of the light assembly on and off.

20. The light having multiple removable mounting capabilities of claim 18 wherein the physical object is a wristband, a wrist strap, a headband, a bicycle mount, a stand or a hanging hook.
